(19) United States
(12) Patent Application Publication
(10) Pub. No.: US 2025/0010386 A1
(43) Pub. Date: Jan. 9, 2025

(54) PORTABLE CUTTING MACHINE

(71) Applicant: MAKITA CORPORATION, Anjo-shi (JP)

(72) Inventors: Sho KUME, Anjo-shi (JP); Koichi TSUDA, Anjo-shi (JP)

(73) Assignee: MAKITA CORPORATION, Anjo-shi (JP)

(21) Appl. No.: 18/893,172

(22) Filed: Sep. 23, 2024

Related U.S. Application Data
(63) Continuation of application No. 18/137,659, filed on Apr. 21, 2023.
Application No. 18/137,659 is a division of application No. 17/157,164, filed on Jan. 25, 2021, now abandoned.

(30) Foreign Application Priority Data
Mar. 24, 2020 (JP) 2020-052400

(51) Int. Cl. B23D 45/16

(52) U.S. Cl. CPC B23D 45/16

(57) ABSTRACT

A portable cutting machine includes an electric motor, a base having a lower surface coming in contact with a workpiece, a cutting machine body coupled to an upper surface of the base and accommodating the electric motor, a handle on a rear portion of the cutting machine body and at least partially rearward from a rear end of the base, a blade on a left or a right of the handle and rotatable with the electric motor, and a battery attachment portion receiving a battery pack for powering the electric motor. The battery attachment portion includes an opening directed away from the blade, an attachment surface standing with respect to the base, and a rail receiver extending in the attachment surface to receive the battery pack in a detachable manner. The battery pack on the rail receiver extends laterally over a center plane of the handle.

### CROSS-REFERENCE TO RELATED APPLICATIONS

This application is a continuation of U.S. patent application Ser. No. 18/137,659, filed Apr. 21, 2023, which is a divisional of U.S. patent application Ser. No. 17/157,164, filed Jan. 25, 2021, which in turn claims the benefit of priority to Japanese Patent Application No. 2020-052400, filed on Mar. 24, 2020, the entire contents of which are hereby incorporated by reference.

### BACKGROUND

### 1. Technical Field

The present disclosure relates to a portable cutting machine called, for example, a rear handle saw.

### 2. Description of the Background

A portable cutting machine called a rear handle saw is a type of handheld cutting machine. A handheld cutting machine has a base to come in contact with a workpiece and a cutting machine body supported on the upper surface of the base. A rear handle saw has a handle, gripped by a user, protruding rearward from the rear end of the base. This type of portable cutting machine has the handle away from the workpiece portion to be machined, thus providing high operability for the user in a standing or half-sitting posture.

A known rechargeable portable cutting machine has a battery pack attached as a power supply. The battery pack, which is relatively heavy, is located not to lower the operability of the cutting machine.

Japanese Unexamined Patent Application Publication No. 2014-148016 (Patent Literature 1) describes a machine in a fourth embodiment (FIGS. 10 to 12) having a battery pack protruding upward from the upper surface of a handle. Patent Literature 1 also describes a machine in a fifth embodiment (FIGS. 13 to 15) having a battery pack protruding rightward from the right front of a handle.

Japanese Unexamined Patent Application Publication No. 2018-99742 (Patent Literature 2) describes a machine having a battery pack compartment parallel to a blade. This machine has a battery pack attached between a handle and a motor housing. The battery pack is attached in a hanging posture with its attachment surface (surface having rails for attachment) facing upward.

### BRIEF SUMMARY

The battery pack attachment structure described in Patent Literature 1 has the battery pack protruding from the outer wall of the machine, thus upsizing the machine. In the battery pack attachment structure described in Patent Literature 2, the battery pack extends over the center plane of the handle in the lateral direction to avoid upsizing of the machine. However, the battery pack is attached to the body in a hanging posture with the upper or attachment surface facing upward, and thus applies the full weight to the attachment portion of the body (in particular, rail receivers on which the battery pack is slid and attached). The attachment portion on the body is to be strong enough to bear the full weight of the battery pack. For a heavier battery pack, the attachment portion may use an additional structure for reinforcement.

A first aspect of the present disclosure provides a portable cutting machine, including:
an electric motor;
a base having a lower surface to come in contact with a workpiece;
a cutting machine body coupled to an upper surface of the base and accommodating the electric motor;
a handle on a rear portion of the cutting machine body and at least partially rearward from a rear end of the base;
a blade on a left or a right of the handle and rotatable with the electric motor; and
a battery attachment portion configured to receive a battery pack for powering the electric motor, the battery attachment portion including
   an opening being open in a direction away from the blade,
   an attachment surface standing with respect to the base, and
   a rail receiver extending in the attachment surface to receive the battery pack in a detachable manner, the battery pack on the rail receiver extending over a center plane of the handle in a lateral direction.

A second aspect of the present disclosure provides a portable cutting machine, including:
an electric motor;
a cutting machine body accommodating the electric motor;
a disc-shaped blade rotatably attached to a right or a left of the cutting machine body;
a front grip on a front portion of the cutting machine body;
a rear handle on a rear portion of the cutting machine body; and
a battery attachment portion configured to receive a battery pack between the front grip and the rear handle, the battery attachment portion including
   a front surface to face a front surface of the battery pack,
   a rear surface to face a rear surface of the battery pack,
   a lateral opening to expose the battery pack in a direction away from the blade,
   a lateral surface opposite to the lateral opening, and
   a rail receiver on the lateral surface, the front surface, or the rear surface, the rail receiver being configured to receive the battery pack in a detachable manner.

### BRIEF DESCRIPTION OF DRAWINGS

FIG. 1 is an overall perspective view of a portable cutting machine according to a first embodiment.

FIG. 2 is a left side view of the portable cutting machine according to the first embodiment as viewed in the direction indicated by arrow II in FIG. 1.

FIG. 3 is a front view of the portable cutting machine according to the first embodiment as viewed in the direction indicated by arrow III in FIGS. 1 and 2.

FIG. 4 is a front view of a cutting machine body in the first embodiment tilted to the left.

FIG. 5 is a left side view of the cutting machine body in the first embodiment swung up.

FIG. 6 is a right side view of the portable cutting machine according to the first embodiment with a battery pack attached.

FIG. 7 is a plan view of the portable cutting machine according to the first embodiment as viewed in the direction indicated by arrow VII in FIG. 6.

FIG. 8 is a right side view of the portable cutting machine according to the first embodiment with the battery pack detached.

FIG. 9 is a plan view of the portable cutting machine according to the first embodiment as viewed in the direction indicated by arrow IX in FIG. 8.

FIG. 10 is a sectional view taken along line X-X in FIG. 6, as viewed in the direction indicated by arrows.

FIG. 11 is a sectional view taken along line XI-XI in FIG. 6, as viewed in the direction indicated by arrows.

FIG. 12 is a view of the cutting machine body, with a stationary cover and a gear housing eliminated, taken along line XII-XII in FIG. 11, as viewed in the direction indicated by arrows for convenience and having outlets viewed from the left.

FIG. 13 is a perspective view of the battery pack alone.

FIG. 14 is an overall perspective view of a portable cutting machine according to a second embodiment.

FIG. 15 is a left side view of the portable cutting machine according to the second embodiment as viewed in the direction indicated by arrow XV in FIG. 14.

FIG. 16 is a front view of the portable cutting machine according to the second embodiment as viewed in the direction indicated by arrow XVI in FIGS. 14 and 15.

FIG. 17 is a front view of a cutting machine body in the second embodiment tilted to the left.

FIG. 18 is a left side view of the cutting machine body in the second embodiment swung up.

FIG. 19 is a right side view of the portable cutting machine according to the second embodiment with a battery pack attached.

FIG. 20 is a right side view of the portable cutting machine according to the second embodiment with the battery pack detached.

FIG. 21 is a longitudinal sectional view of a controller compartment and a battery attachment portion taken along line XXI-XXI in FIG. 19, as viewed in the direction indicated by arrows.

FIG. 22 is a sectional view taken along line XXII-XXII in FIG. 20, as viewed in the direction indicated by arrows with the battery pack detached.

### DETAILED DESCRIPTION

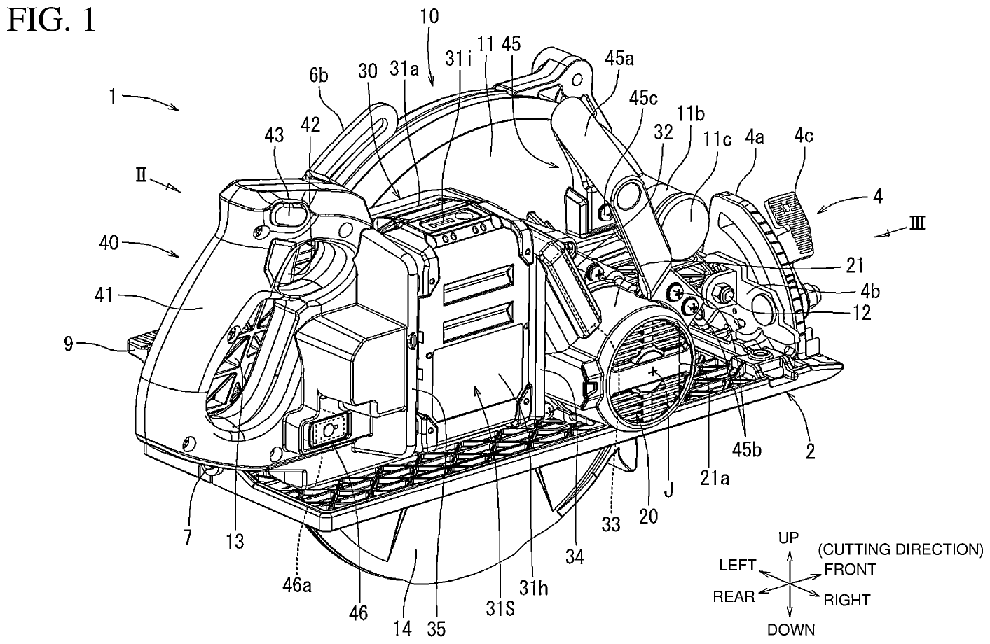

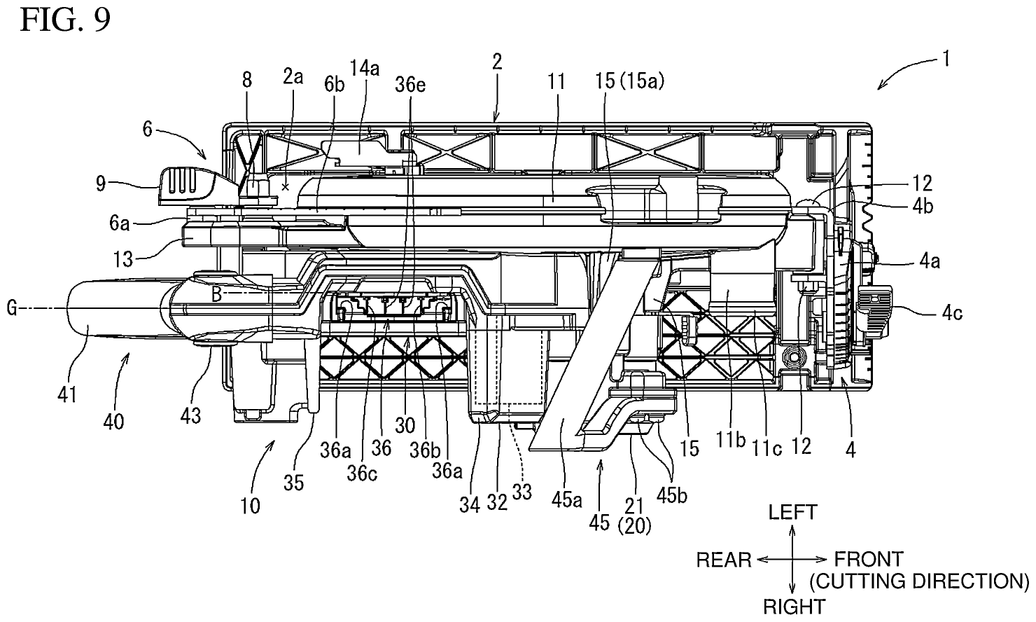

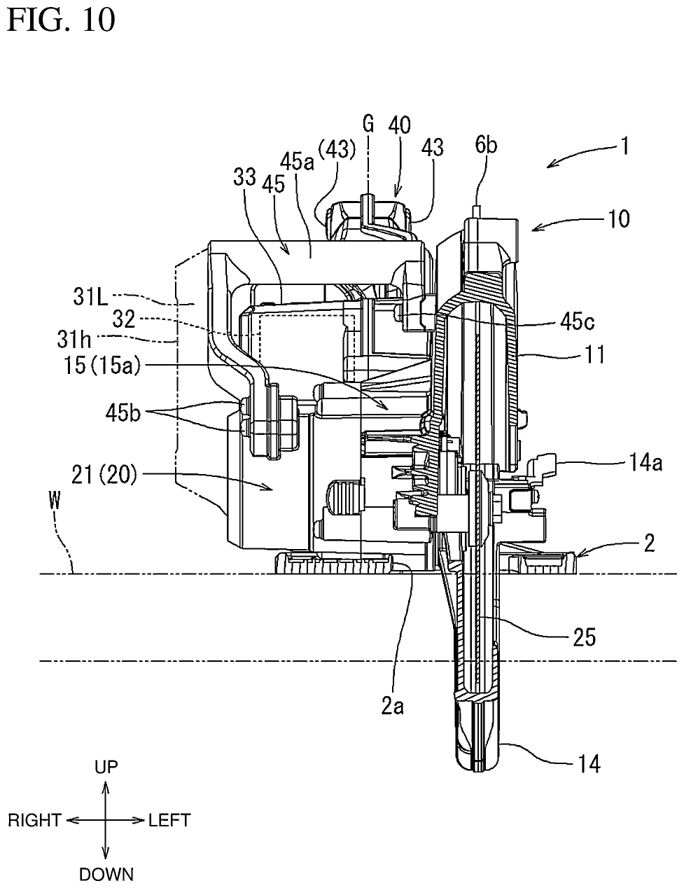

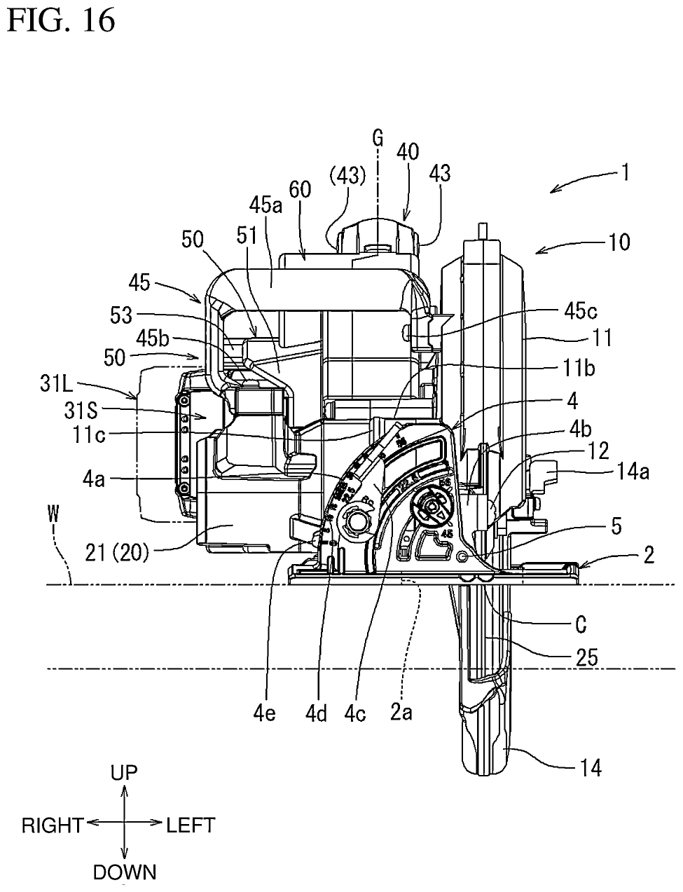

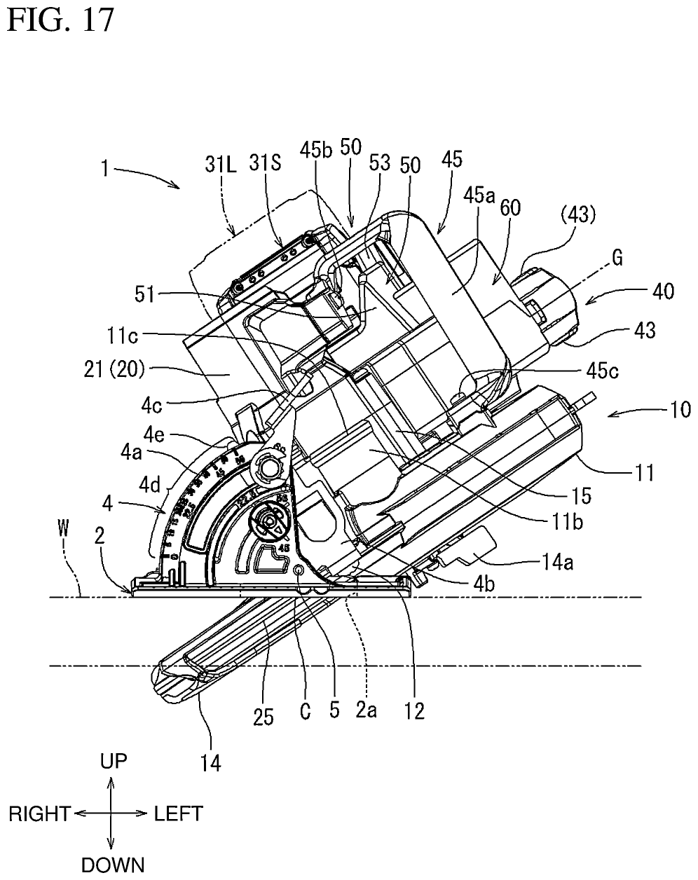

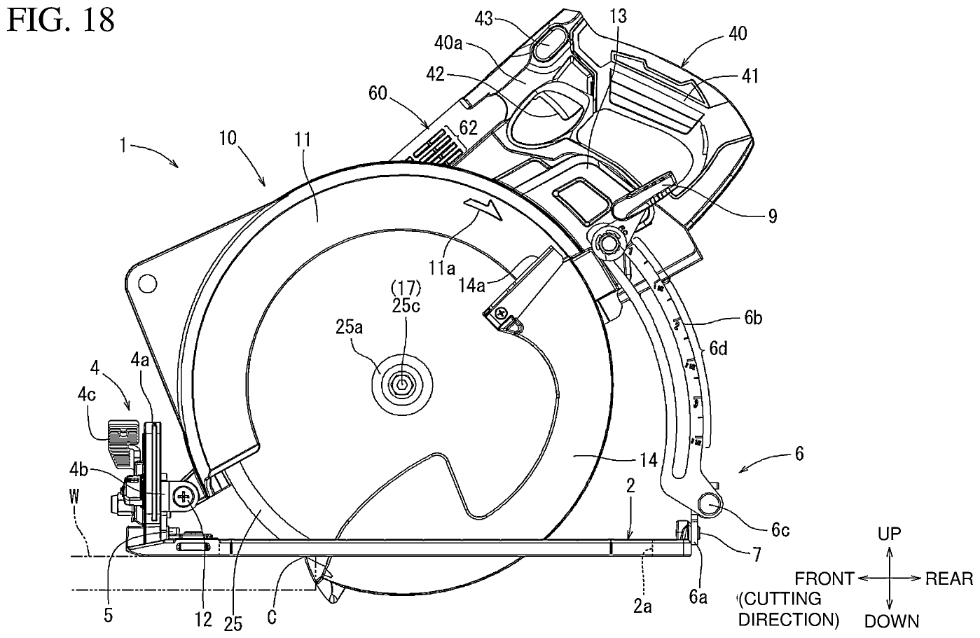

A portable cutting machine 1 according to one or more embodiments will now be described with reference to FIGS. 1 to 22. FIGS. 1 to 12 show the portable cutting machine 1 according to a first embodiment. The portable cutting machine 1 according to the present embodiment is, for example, a handheld cutting machine called a rear handle saw. The portable cutting machine 1 has a handle 40 protruding largely rearward, mainly for cutting a workpiece at the foot of a user in a standing posture.

The portable cutting machine 1 includes a cutting machine body 10 and a base 2. The cutting machine body 10 includes a circular blade 25, called a tipped saw blade, which is rotatable with an electric motor 20 as a drive source. The base 2 supports the cutting machine body 10 on the upper surface. The base 2 has a window 2a substantially rectangular and elongated in the front-rear direction. The blade 25 has a lower portion protruding below the lower surface of the base 2 through the window 2a. The workpiece W is cut with the blade 25 protruding from the lower surface of the base 2.

The cutting machine body 10 includes, on its rear, a handle 40 gripped by a user. The user, facing the rear of the portable cutting machine 1, grips the handle 40 and moves the portable cutting machine 1 forward to advance cutting. In the figures, the direction in which cutting advances is referred to as a cutting direction.

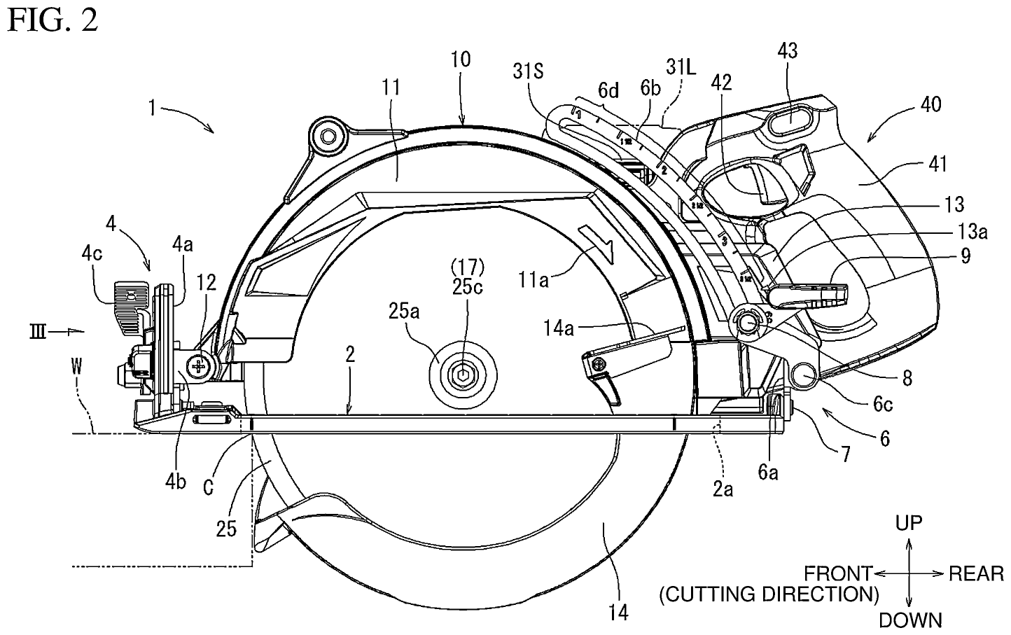

The components and structure will be described herein by referring to the front-rear direction with the front being the cutting direction and the rear being where the user stays. The lateral direction is defined for the components and structure as viewed from the user. As shown in FIG. 2, the blade 25 has a cutting edge intersecting with the lower surface of the base 2 at the front. This portion of intersection (cutting portion C) first cuts into the workpiece W. Chips are blown up from the cutting portion C and collected into a stationary cover 11.

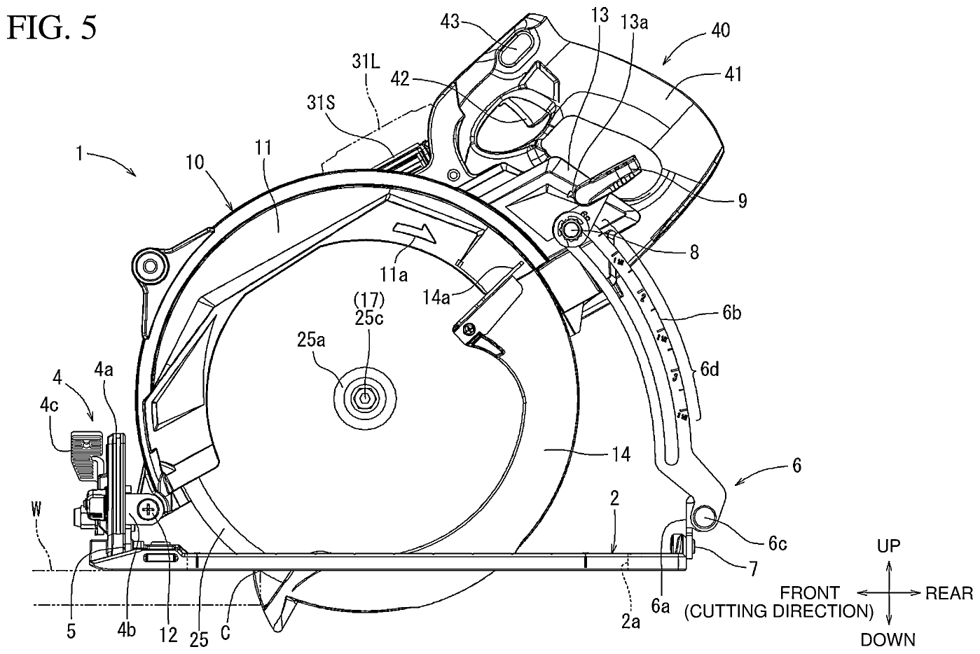

The cutting machine body 10 includes the stationary cover 11. The stationary cover 11 covers substantially the upper half of the blade 25. The cutting machine body 10 is supported on the upper surface of the base 2 in a vertically swingable manner about a vertical swing support shaft 12 at the front of the stationary cover 11. As shown in FIG. 5, the cutting machine body 10 is vertically swung about the vertical swing support shaft 12 to change the degree of protrusion of the blade 25 below the lower surface of the base 2. This adjusts the cutting depth of the blade 25 into the workpiece W.

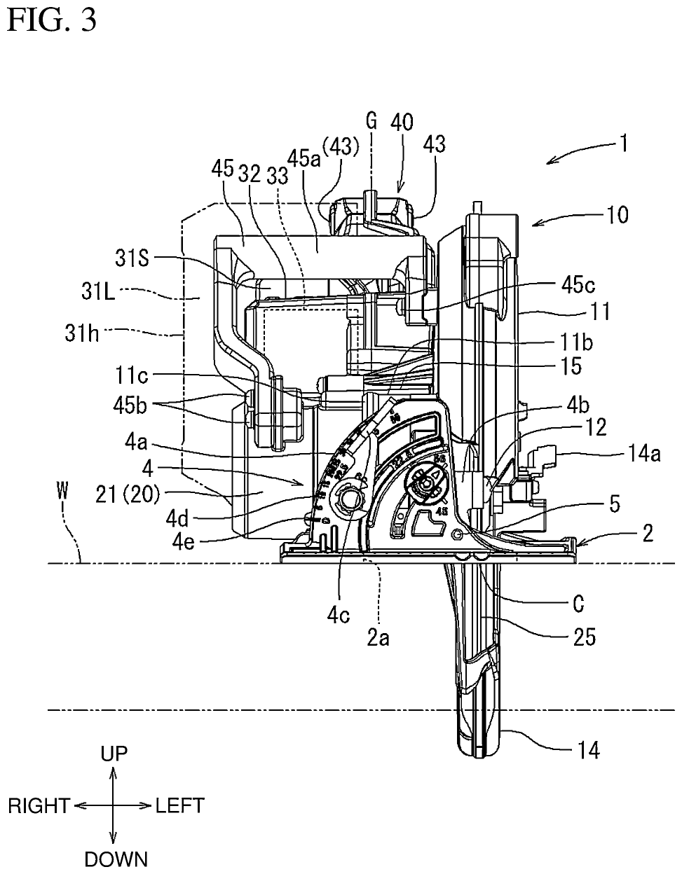

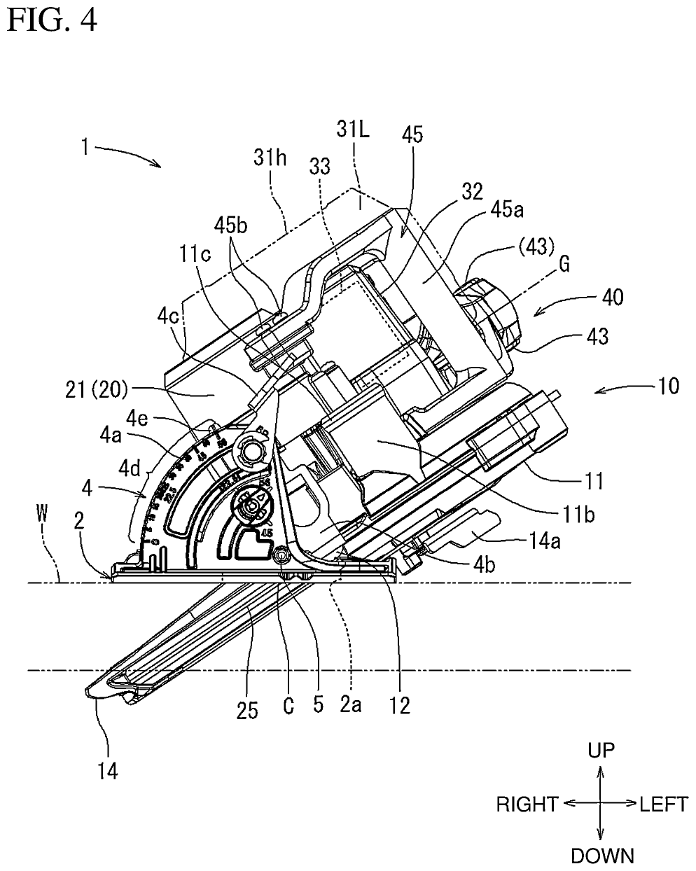

The cutting machine body 10 is coupled to a front tilt support 4 located on the upper surface of the base 2 with the vertical swing support shaft 12. As shown in FIGS. 3 and 4, the front tilt support 4 includes an angular plate 4a and a tilt bracket 4b. The angular plate 4a stands on and is fixed to the upper surface of the base 2. The tilt bracket 4b is supported on the rear surface of the angular plate 4a in a vertically swingable manner about a front lateral tilt support shaft 5. The tilt bracket 4b supports the vertical swing support shaft 12. The tilt bracket 4b is locked at any tilt position relative to the angular plate 4a by tightening a locking lever 4c.

As shown in FIG. 2, a rear tilt support 6 is located between the rear of the stationary cover 11 and the upper surface of the base 2. The rear tilt support 6 includes a base bracket 6a and a depth guide 6b. The base bracket 6a is supported to be tiltable about a rear lateral tilt support shaft 7 to the right and left relative to the base 2. The depth guide 6b is supported in a manner swingable forward and backward about a front-rear pivot shaft 6c relative to the base bracket 6a.

The rear lateral tilt support shaft 7 is coaxial with the front lateral tilt support

shaft 5. The cutting machine body 10 is tilted about the front lateral tilt support shaft 5 and the rear lateral tilt support shaft 7 to the right or left to adjust the angle of the blade 25 to cut into the workpiece W. FIG. 4 shows the cutting machine body 10 tilted about 56° to the left. The angular plate 4a has a periphery with an angle marking 4d indicating the tilt angle of the cutting machine body 10. The tilt bracket 4b has an indicator 4e. The tilt angle indicated by the indicator 4e can be read to accurately determine the tilt angle of the cutting machine body 10.

The depth guide 6b is an arc-shaped guide for guiding the cutting machine body 10 to swing in the vertical direction. A body fastener screw 8 is tightened into a handle support 13 (described later) to lock the cutting machine body 10 at any vertical swing position relative to the depth guide 6b. This allows the blade 25 to protrude by a constant degree below the lower surface of the base 2 to maintain a constant cutting depth into the workpiece W.

As shown in FIGS. 2 and 5, the depth guide 6b has an edge with a depth scale 6d indicating the cutting depth of the blade 25. The handle support 13 has a triangular indicator 13a on its left side surface. The depth scale 6d indicated by the indicator 13a can be read to accurately determine the cutting depth.

The locking lever 9 is vertically operable to tighten or loosen the body fastener screw 8. As shown in FIGS. 2 and 5, the rotation direction of the blade 25 is indicated by a solid-white arrow 11a on the side surface of the stationary cover 11. The blade 25 rotates clockwise in FIG. 2 to cause chips to be blown up from the cutting portion C. The blown-up chips are carried with an airflow generated by the rotating blade 25 and collected into the stationary cover 11.

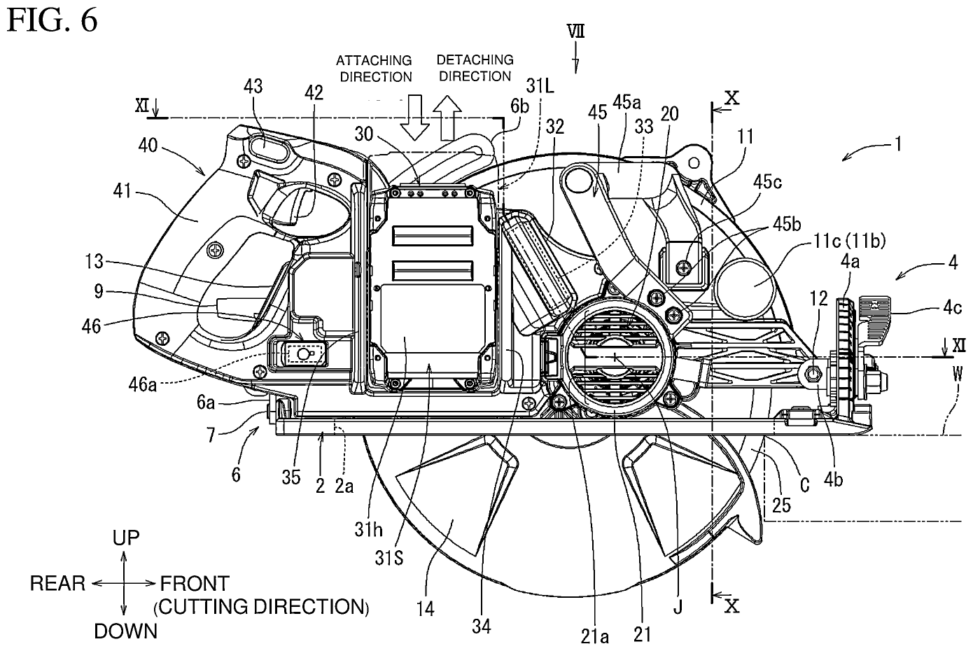

As shown in FIGS. 6 to 9, the stationary cover 11 has a dust collecting port 11b on the front right portion. In the figures, the dust collecting port 11b is covered with a cap 11c. Although not shown in the figures, the dust collecting port 11b may have the cap 11c removed to receive a dust collecting hose connecting to a dust collector. The dust collector can efficiently collect generated chips. The dust collecting port 11b may also receive a dust bag (dust collecting bag) instead of the dust collecting hose. Dust is collected with the dust collector or the dust bag to maintain a clean work environment.

The blade 25 has the lower half substantially covered with a movable cover 14. The movable cover 14 is supported to open and close substantially about the rotation center of the blade 25. The movable cover 14 opens to uncover the circumference (cutting edge) of the blade 25. The movable cover 14 is urged to close by a spring. The movable cover 14 closed under an urging force from the spring covers substantially the lower half of the blade 25. The movable cover 14 has an open-close lever 14a on its rear. A user can manually force the movable cover 14 to open and close by gripping the open-close lever 14a. In a normal cutting operation, as shown in FIG. 2, the portable cutting machine 1 is moved forward with the movable cover 14 having the front end in contact with an end of the workpiece W. This causes the movable cover 14 to gradually open against the urging force applied from the spring.

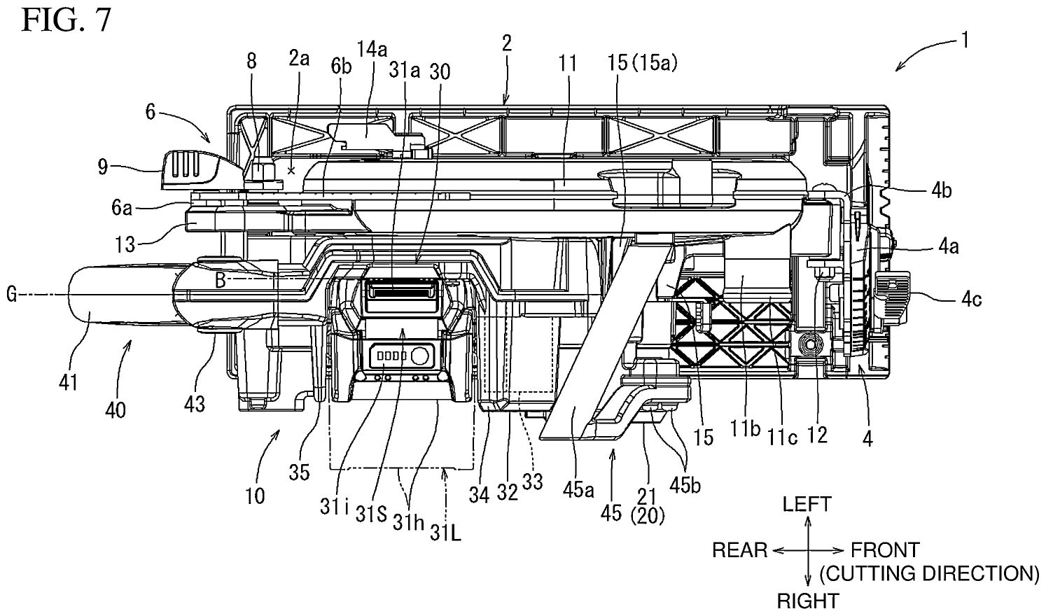

As shown in FIGS. 7 and 9 to 11, the stationary cover 11 receives the electric motor 20 on the right surface with a reduction gear 15 between them. The electric motor 20 is attached to extend in the lateral direction, or more specifically to have a motor axis J extending orthogonal to the plane direction of the blade 25. The reduction gear 15 includes a gear housing 15a integral with the stationary cover 11 on the right. The gear housing 15a accommodates a reduction gear train. The stationary cover 11 and the gear housing 15a are integrally formed by magnesium die-casting. The gear housing 15a is coupled with a motor housing 21 formed by aluminum die-casting.

The electric motor 20 is a brushless motor with a rotor 23 rotatably supported inward from the inner circumference of a cylindrical stator 22. The electric motor 20, which does not include, for example, commutators and brushes on the rotor 23, has a smaller axial (lateral) dimension. The rotor 23 is supported on a motor shaft 24 that is supported rotatably about the axis with front and rear bearings 24b and 24c in the axial direction. The front bearing 24b is held on the gear housing 15a. The rear bearing 24c is held on the rear surface of the motor housing 21. The motor shaft 24 receives a cooling fan 27 between the front bearing 24b and the rotor 23.

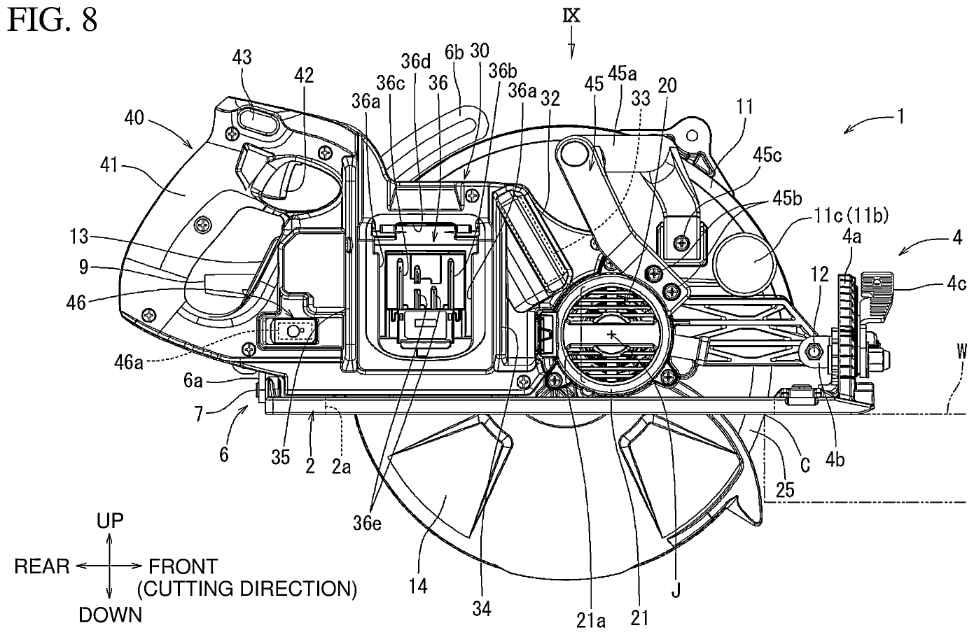

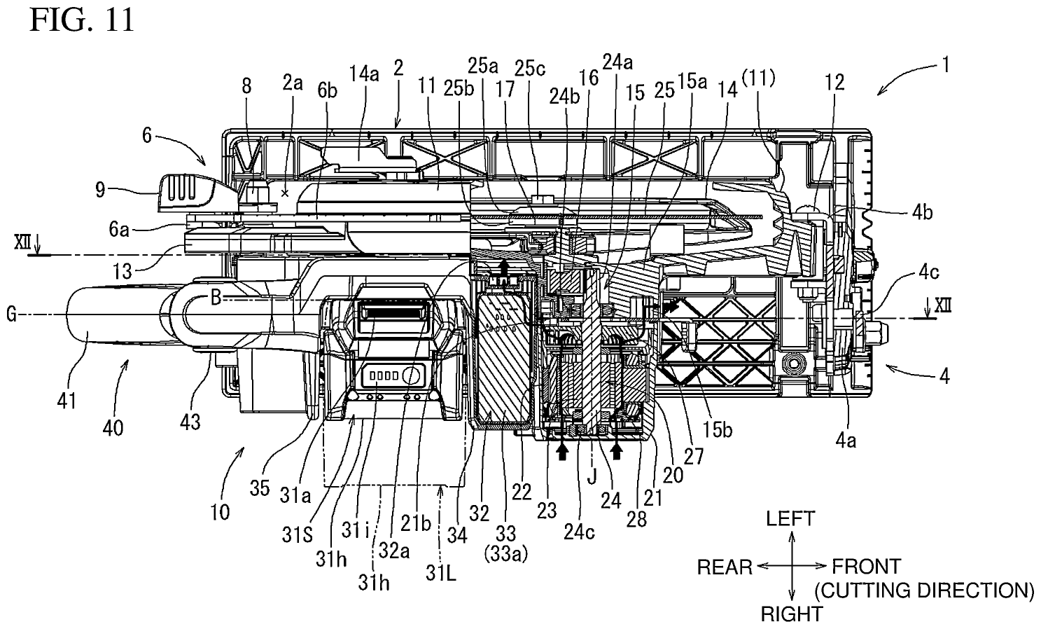

As shown in FIGS. 6 and 8, the motor housing 21 has a left end face having multiple inlets 21a. The electric motor 20 is activated to rotate the cooling fan 27 to draw outside air into the motor housing 21 through the inlets 21a. As indicated by the thick bold arrows in FIG. 11, outside air drawn through the inlets 21a flows toward the output end along the motor axis J, while cooling the stator 22 and the rotor 23.

The motor shaft 24 receives a driving gear 24a at the distal end (left end). The driving gear 24a is meshed with a follower gear 16. The driving gear 24a and the follower gear 16 meshing with each other form a reduction gear train for reducing the rotation output from the electric motor 20. The follower gear 16 is integrally coupled to a spindle 17. Although not shown in the figure, the spindle 17 is rotatably supported on the gear housing 15a with two bearings arranged in the axial direction. The spindle 17 is parallel to the motor shaft 24.

The spindle 17 has the distal end protruding into the stationary cover 11 to receive the blade 25. The blade 25 is held between an outer flange 25a and an inner flange 25b in the direction orthogonal to the plane. The blade 25 held between the flanges is locked with a fastener screw 25c tightened into the distal end face of the spindle 17. This allows the blade 25 to be axially immovable and nonrotatable about the axis relative to the spindle 17.

As shown in FIGS. 6 to 9 and 11, a controller compartment 32 is located on the right of the stationary cover 11 and behind the electric motor 20. The controller compartment 32 accommodates a controller 33. The controller 33 includes a control board 33a including a power circuit and a control circuit for controlling the operation of the electric motor 20. The stator 22 receives a sensor board 28 at an end opposite to the blade in the direction of the motor axis J. The sensor board 28 includes a magnetic sensor for detecting the rotational position of the rotor 23. The control board 33a in the controller 33 receives a control circuit. The control circuit transmits a control signal based on the positional information about the rotor 23 obtained by the sensor board 28. The control board 33a also receives a drive circuit. The drive circuit switches a current through the electric motor 20 in response to the control signal received from the control circuit. The control board 33a also receives an automatic stop circuit. The automatic stop circuit cuts power supply to the electric motor 20 to prevent overdischarge or overcurrent in accordance with the detected status of the battery pack 31.

The controller 33 includes a shallow rectangular aluminum case accommodating the control board 33a. The control board 33a is molded with a resin for insulation. As shown in FIGS. 6 and 8, the controller compartment 32 has an upper portion tilting rearward. The controller 33 accommodated in the controller compartment 32 also has an upper portion tilting rearward. The controller 33, which is relatively large, can thus be accommodated in a smaller space both in the front-rear direction and the vertical direction.

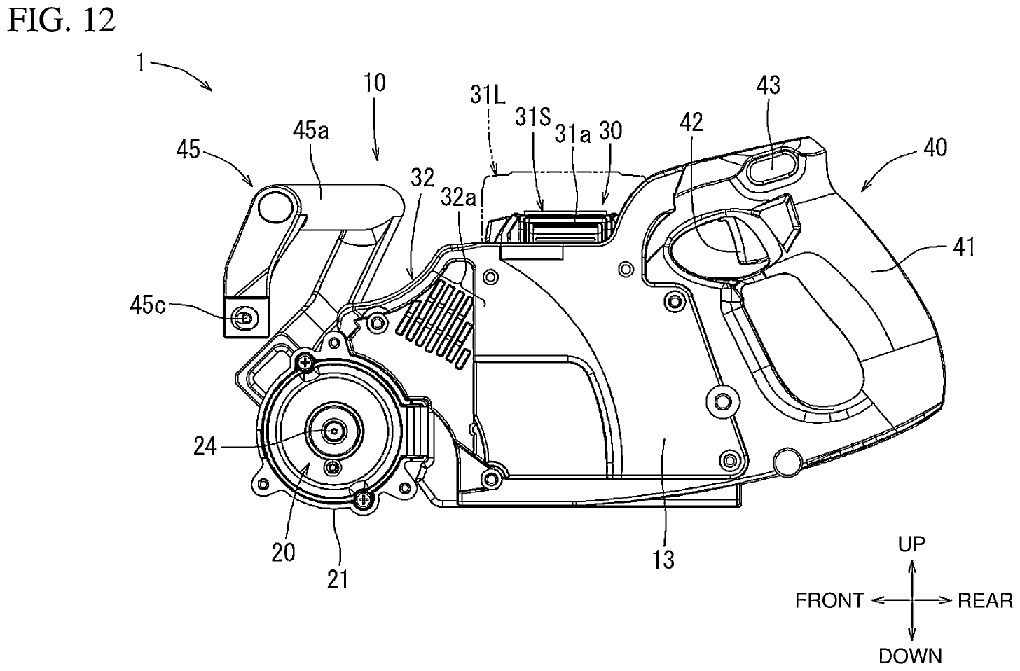

As shown in FIG. 11, the controller compartment 32 communicates with the motor housing 21 through an air vent 21b. The air vent 21b is located behind the cooling fan 27. Thus, the motor cooling air drawn into the motor housing 21 in response to rotation of the cooling fan 27 flows into the controller compartment 32 through the air vent 21b efficiently, as indicated by the thick bold arrows in FIG. 11. The motor cooling air flowing into the controller compartment 32 efficiently cools the controller 33. The motor cooling air flowing into the controller compartment 32 flows out through outlets 32a on the left end face of the controller compartment 32. FIG. 12 shows the outlets 32a.

The motor cooling air drawn into the motor housing 21 also flows out through outlets 15b on the front surface of the gear housing 15a.

A battery attachment portion 30 is located behind the controller compartment 32. The battery attachment portion 30 receives a single battery pack 31. The battery attachment portion 30 will be described in detail later. A D-shaped handle 40 is located behind the battery attachment portion 30. The handle 40 extends substantially parallel to the plane direction (front-rear direction) of the blade 25. The handle 40 protrudes rearward from the rear of the battery attachment portion 30. The handle 40 protrudes further rearward from the rear end of the base 2. The blade 25 is on the right or left of the handle 40 (on the left in the present embodiment).

The handle 40 has a rear portion extending in the vertical direction as a grip 41 gripped by a user. The grip 41 includes a trigger switch lever 42 on its upper portion. The user pulls the switch lever 42 with the fingers holding the grip 41 to activate the electric motor 20, which rotates the blade 25. The surface of the grip 41 and a portion around the switch lever 42 are coated with a non-slip elastomer resin.

The handle 40 has an unlock button 43 above the switch lever 42. The switch lever 42 is normally locked and cannot be pulled. The user presses the unlock button 43 with a finger to unlock the switch lever 42 at the off position, enabling the switch lever 42 to be pulled. The user stops pulling the switch lever 42 to automatically return the switch lever 42 to the locked state at the off position. This prevents the switch lever 42 from being pulled accidentally.

The stationary cover 11 has a rear portion integral with the handle support 13. The handle support 13 is a flat plate formed by die-casting, similar to the stationary cover 11. The handle support 13 in the present embodiment is integral with the stationary cover 11. The handle support 13 protrudes rearward from the rear of the stationary cover 11. The handle support 13 extends parallel to the plane direction of the blade 25. The handle support 13 receives the battery attachment portion 30 and the handle 40 coupled with screws at multiple points in the front-rear direction.

The handle 40 is coupled to the stationary cover 11 with the handle support 13 between them. Thus, the handle 40 largely protruding rearward is supported rigidly, preventing or reducing bending of the handle 40 mainly in the lateral direction.

A sub grip 45 is located above the electric motor 20. As shown in FIGS. 3, 4, and 6 to 10, the sub grip 45 is in the shape of a gate extending between the upper front surface of the electric motor 20 and the right surface of the stationary cover 11. The sub grip 45 has a right end coupled to the motor housing 21 with two screws 45b. The sub grip 45 has a left end coupled to the stationary cover 11 with one screw 45c.

The sub grip 45 includes, in the upper portion, a grip 45a extending substantially in the lateral direction. The user grips the grip 45a with, for example, the left hand, and grips the grip 41 of the handle 40 with the right hand to move the portable cutting machine 1. The grip 45a is parallel to the base 2, and is inclined more frontward at more leftward positions in a plan view. The user can grip the inclined grip 45a more easily with the left hand.

As shown in FIGS. 6 and 8, an adapter compartment 46 is located on the right surface of the handle 40. The adapter compartment 46 accommodates a communication adapter 46a for near field communication. The communication adapter 46a allows near field communication between the portable cutting machine 1 and other wireless devices. For example, the near field communication allows a dust collector connected to the dust collecting port 11b through a dust collecting hose to be activated or deactivated in response to the portable cutting machine 1 being activated or deactivated. The near field communication allows the user to efficiently continue cutting in a constantly clean work environment. The communication adapter 46a is detachable from the adapter compartment 46. The detached communication adapter 46a can be used for other power tools compatible with this communication adapter 46a.

The battery attachment portion 30 is behind the controller compartment 32 and in front of the handle 40 in the front-rear direction. The battery attachment portion 30 has a front wall 34 at the front and a rear wall 35 at the rear. The front and rear walls 34 and 35 are parallel to each other and extend rightward (away from the blade 25) by the same dimension. The two walls 34 and 35 have substantially the same height in the vertical direction. The front wall 34 has an upper portion connected to an upper portion of the controller compartment 32.

The battery attachment portion 30 receives a single battery pack 31 between the front and rear walls 34 and 35. As shown in FIG. 8, the battery attachment portion 30 has a terminal mount 36 on its left end in an inner space between the front and rear walls 34 and 35. The terminal mount 36 includes a pair of rail receivers 36a and positive and negative power terminals 36b and 36c. The terminal mount 36 includes two signal terminals 36e between the positive and negative power terminals 36b and 36c. The pair of rail receivers 36a extend vertically and parallel to each other on the front and the rear portions of the terminal mount 36. The terminal mount 36 includes the positive and negative power terminals 36b and 36c between the front and rear rail receivers 36a. The positive and negative power terminals 36b and 36c are spaced from each other in the front-rear direction and extend vertically. The terminal mount 36 has a lock recess 36d on the upper portion for locking the battery pack 31 as attached.

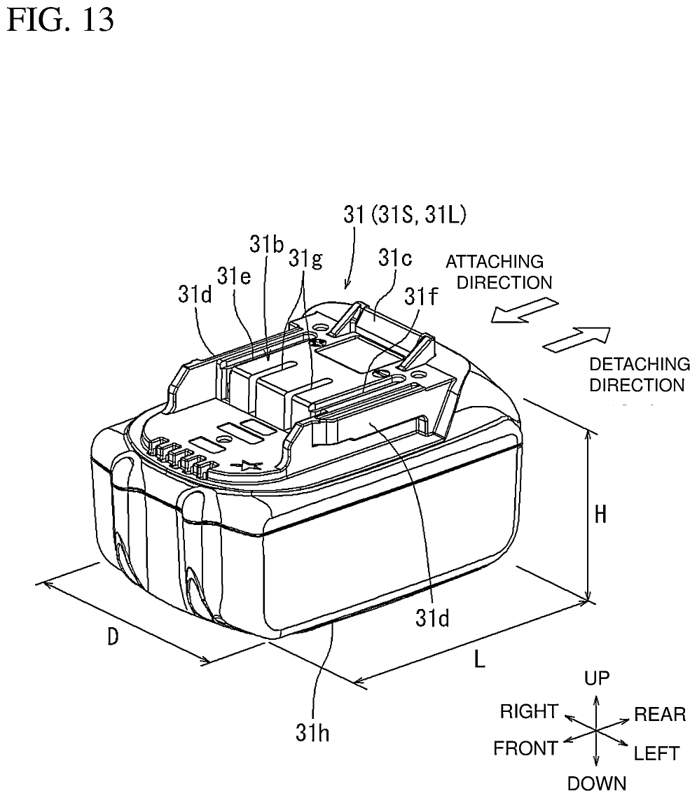

As shown in FIG. 13, the battery pack 31 is a rechargeable battery with a rectangular parallelepiped shape and attachable by sliding. The battery pack 31 is a general-purpose lithium ion battery that can also be attached as a power supply to other power tools such as a screwing machine. As shown in the figure, the battery pack 31 has a length L in the front-rear direction, a width D in the lateral direction, and a height H in the vertical direction. In the figure, the battery pack 31 has an upper surface defining a connection surface 31b for connecting to the terminal mount 36. The connection surface 31b has a pair of right and left rails 31d extending in the front-rear direction. The connection surface 31b has positive and negative terminal slots 31e and 31f between the right and left rails 31d. The connection surface 31b has two signal terminal slots 31g between the positive and negative terminal slots 31e and 31f.

The connection surface 31b has a lock tab 31c at the rear. The lock tab 31c is urged toward the protruding end (lock position) by a spring. The battery pack 31 includes a release button 31a behind the lock tab 31c. The release button 31a is not shown in FIG. 13. The release button 31a is shown in FIGS. 7 and 11. Pressing the release button 31a lowers the lock tab 31c to the unlock position against the urging force from the spring. FIG. 13 shows the battery pack 31 alone using the front-rear, lateral, and vertical directions defined in a manner specific to this figure. The connection surface 31b is an upper surface, the attaching direction is a frontward direction, and the detaching direction is a rearward direction. The lateral (right-left) direction is defined as viewed in the attaching direction.

The battery pack 31 has the connection surface 31b for connecting to the terminal mount 36, and the connection surface 31b corresponds to an attachment surface B. The attachment surface B stands with respect to the base 2. As shown in FIG. 7, the battery pack 31 has the attachment surface B located on the left (adjacent to the blade 25) of the center line (width center G) in the lateral or width direction of the handle 40. Thus, the battery pack 31 attached to the battery attachment portion 30 partially extends over the width center G of the handle 40 to an area adjacent to the blade 25. With the attachment surface B standing with respect to the base 2, the battery pack 31 is attached to have its lower surface 31h (opposite to the connection surface 31b) standing with respect to the base 2. Thus, as shown in FIG. 6, the battery pack 31 is attached to the battery attachment portion 30 with the lower surface 31h facing rightward.

The battery pack 31 is slid downward with the front surface facing downward as indicated by the solid-white arrow in FIG. 6 to be attached to the battery attachment portion 30. The battery pack 31 is slid downward to be attached with the pair of rails 31d engaged with the pair of rail receivers 36a on the terminal mount 36. The battery pack 31 as attached has the connection surface 31b (attachment surface B) facing the terminal mount 36. The battery pack 31 as attached is locked with the lock tab 31c engaged with the lock recess 36d.

When the battery pack 31 is slid downward, the positive and negative terminal slots 31ₑ and 31f receive the positive and negative power terminals 36b and 36c. The signal terminal slots 31g receive the signal terminals 36e on the terminal mount 36. This allows power supply from the battery pack 31 to the cutting machine body 10, and also allows transmission and reception of various data signals between the battery pack 31 and the cutting machine body 10.

FIGS. 7 and 11 show the rear surface of the battery pack 31 attached to the battery attachment portion 30. The battery pack 31 has the rear surface receiving a battery indicator 31i in addition to the release button 31a. The battery indicator 31i indicates the remaining battery level of the battery pack 31.

The release button 31a is depressed toward the lower surface 31h to cause the lock tab 31c to retract from the lock recess 36d for unlocking. The unlocked battery pack 31 can be slid upward relative to the battery attachment portion 30 for detachment. The battery pack 31 can be detached from the battery attachment portion 30 and charged with a separate charger. Thus, the battery pack 31 can be used repeatedly as a power supply.

The battery attachment portion 30 selectively receives two different battery packs: a low-capacity, small first battery pack 31S, and a high-capacity, large second battery pack 31L. The battery packs 31S and 31L with such different capacities have different lengths L and different heights H. The large second battery pack 31L has a greater length L and a greater height H than the small first battery pack 31S. The two different battery packs 31S and 31L have substantially the same width D. The distance between the front and rear walls 34 and 35 in the front-rear direction is determined in accordance with the width D. The large and small battery packs 31S and 31L each have a width D small enough to create narrow clearances between the battery pack 31S or 31L and the front and rear walls 34 and 35. The connection surface 31b is common between the second battery pack 31L and the first battery pack 31S.

The second battery pack 31L has a greater length L than the first battery pack 31S. As shown in FIG. 6, the first battery pack 31S is attached without protruding from the upper ends of the front and rear walls 34 and 35. The second battery pack 31L is attached to protrude from the upper ends of the front and rear walls 34 and 35. Thus, the battery attachment portion 30 defined by the front and rear walls 34 and 35 is open upward to allow the second battery pack 31L to be attached to protrude upward from between the front and rear walls 34 and 35. The large and small battery packs 31S and 31L each have the width D slightly less than the distance between the walls 34 and 35. This allows the front and rear walls 34 and 35 to guide the battery pack 31S or 31L for attachment. More specifically, the walls 34 and 35 can smoothly guide the battery pack 31S or 31L inserted near an end of the space between the walls 34 and 35 to move to the attachment surface.

The second battery pack 31L has a greater height H than the first battery pack 31S. As shown in FIG. 7, when the first battery pack 31S is attached to the battery attachment portion 30, the lower surface 31h does not protrude from the extending ends of the walls 34 and 35. When the second battery pack 31L having a greater height H is attached to the battery attachment portion 30, the lower surface 31h protrudes rightward from the extending ends of the walls 34 and 35. Thus, the battery attachment portion 30 defined by the front and rear walls 34 and 35 is also open rightward to selectively receive the large and small battery packs 31S and 31L having different capacities.

The portable cutting machine 1 according to the first embodiment includes the battery attachment portion 30 extending over the width center G of the handle 40 in the lateral direction to an area adjacent to the blade 25. Thus, the battery pack 31 attached to the battery attachment portion 30 extends over the width center G of the handle 40 to overlap an area adjacent to the blade 25. This allows the battery pack 31 to be attached in a space-efficient manner in the lateral direction than a battery pack located on one side of the portable cutting machine 1 with respect to the width center G.

The battery pack 31 (31S, 31L) is attached or detached in the vertical direction forming an angle with the front-rear direction. The attachment surface B stands with respect to the base 2 or extends in the vertical direction (the direction of gravity). This allows the battery attachment portion 30 to receive the full weight of the attached battery pack 31 on the attachment surface B. Thus, the battery pack 31 has the full weight applied dispersedly on the rail receivers 36a and other parts. More specifically, the battery attachment portion 30 partially receives the weight of the battery pack 31 with, for example, friction caused by the battery pack 31 in contact with or engaged with the battery attachment portion 30 in the sliding direction. This avoids the battery pack 31 with the full weight applied locally on the rail receivers 36a on the battery attachment portion 30. In a known attachment structure, a battery pack is attached in a hanging posture with the sliding direction crossing the direction of gravity. In such a structure, the battery pack has the full weight applied locally on rail receivers. The battery attachment portion 30 in the present embodiment can receive the large second battery pack 31L with no or less additional reinforcement for, for example, the rail receivers 36a and parts near the rail receivers 36a.

The battery attachment portion 30 is open in the direction opposite to the blade 25, or rightward (in the direction away from the blade 25). Thus, the large second battery pack 31L is attached to protrude rightward from the front and rear walls 34 and 35. With the large second battery pack 31L, the attachment surface B is located adjacent to the blade 25 with respect to the width center G of the handle 40. Thus, the large second battery pack 31L is attached in a space-efficient manner in the lateral direction. The large second battery pack 31L extends over the width center G of the handle 40 to overlap an area adjacent to the blade 25. Thus, the large second battery pack 31L has the center of gravity closer to the width center G of the handle 40. This allows the user to move the portable cutting machine 1 by gripping the handle 40 more easily.

The battery attachment portion 30 has the walls 34 and 35 at the front and the rear. The front and rear walls 34 and 35 protect the battery pack 31 attached to the battery attachment portion 30. The front and rear walls 34 and 35 serve as a battery guard.

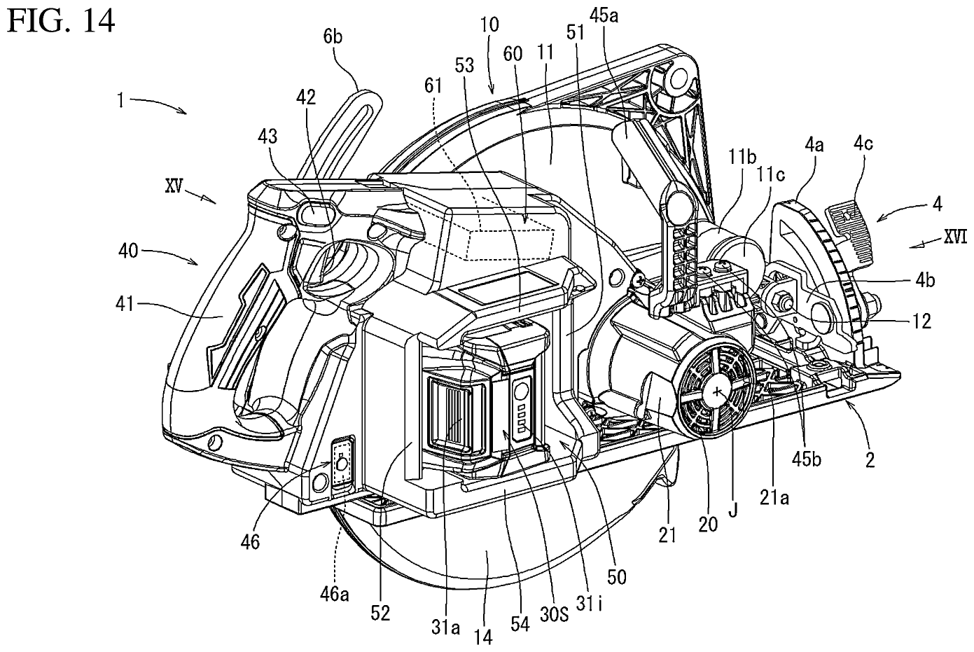

In the first embodiment described above, the battery pack 31 is slid in the vertical direction to be attached to or detached from the battery attachment portion 30. However, the battery pack 31 may be slid in the lateral direction to be attached or detached. FIG. 14 and subsequent figures show a portable cutting machine 1 according to a second embodiment. The parts and components similar to those in the first embodiment without any modification are denoted by the corresponding reference numerals and are either described briefly or not described repeatedly.

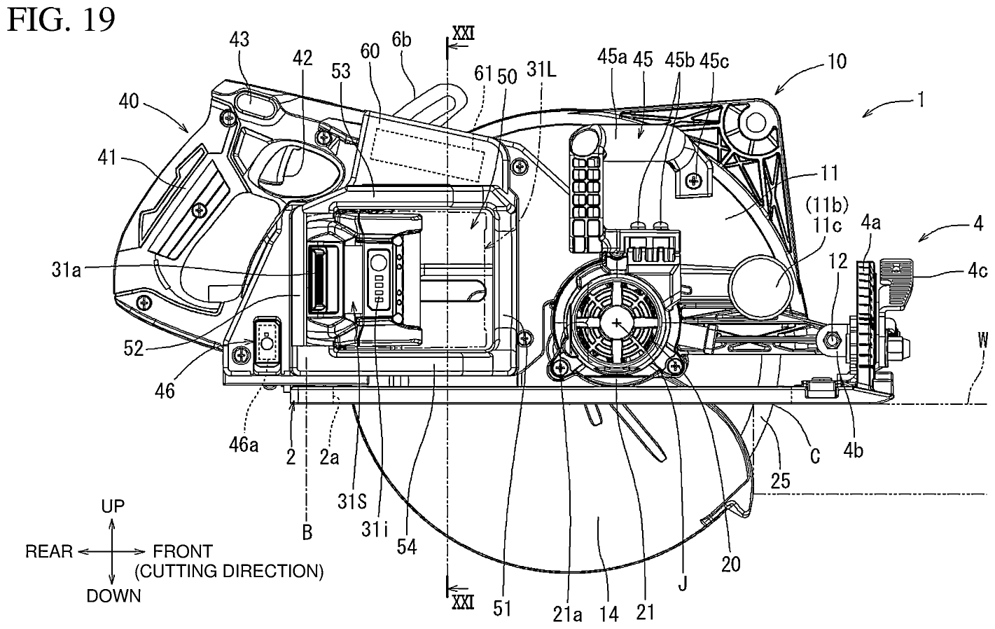

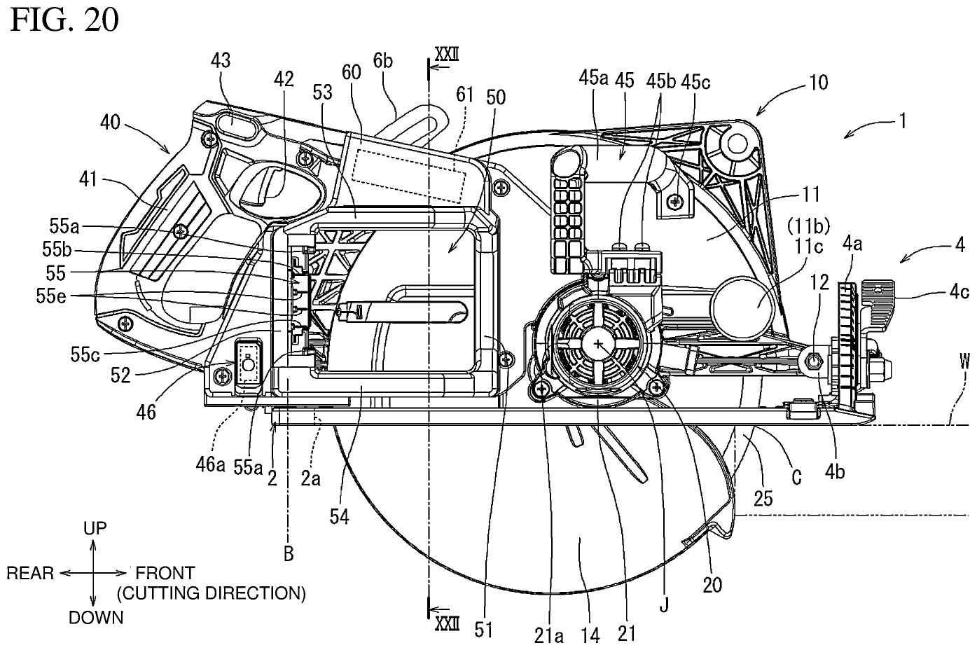

In the portable cutting machine 1 according to the second embodiment, the battery pack 31 is slid in the lateral direction (a direction crossing the blade 25) to be attached or detached. As shown in FIGS. 19 and 20, a battery attachment portion 50 in the second embodiment is located behind the electric motor 20 and on the right surface of the handle support 13, similarly to the battery attachment portion 30 in the first embodiment.

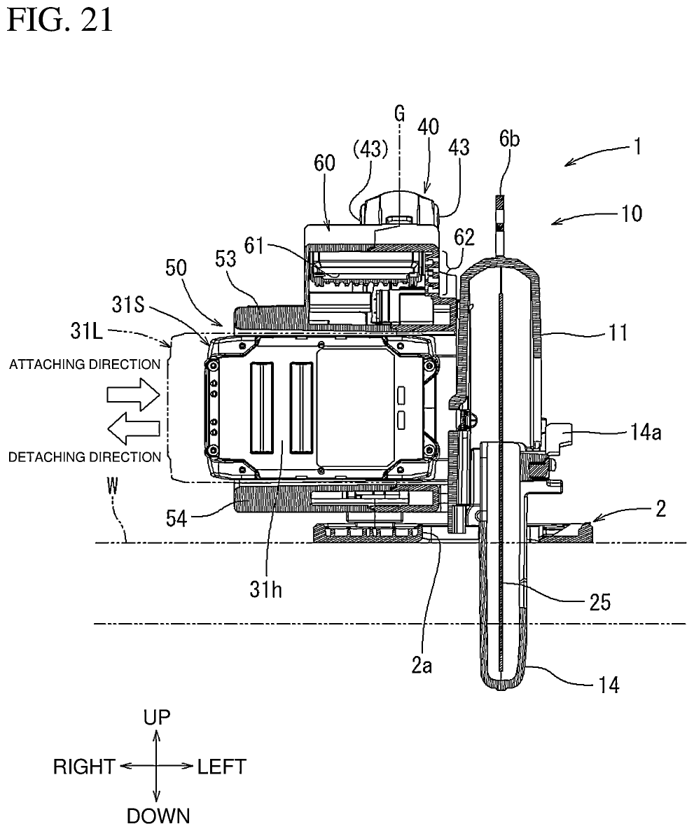

The battery attachment portion 50 in the second embodiment has a front wall 51 at the front and a rear wall 52 at the rear. The battery attachment portion 50 has an upper wall 53 at the top and a lower wall 54 at the bottom. The front wall 51, the rear wall 52, the upper wall 53, and the lower wall 54 define a rectangular battery compartment. As shown in FIG. 21, the upper wall 53 and the lower wall 54 are parallel to each other and extend rightward largely. The front wall 51 and the rear wall 52 extend rightward by a lesser degree than the upper wall 53 and the lower wall 54.

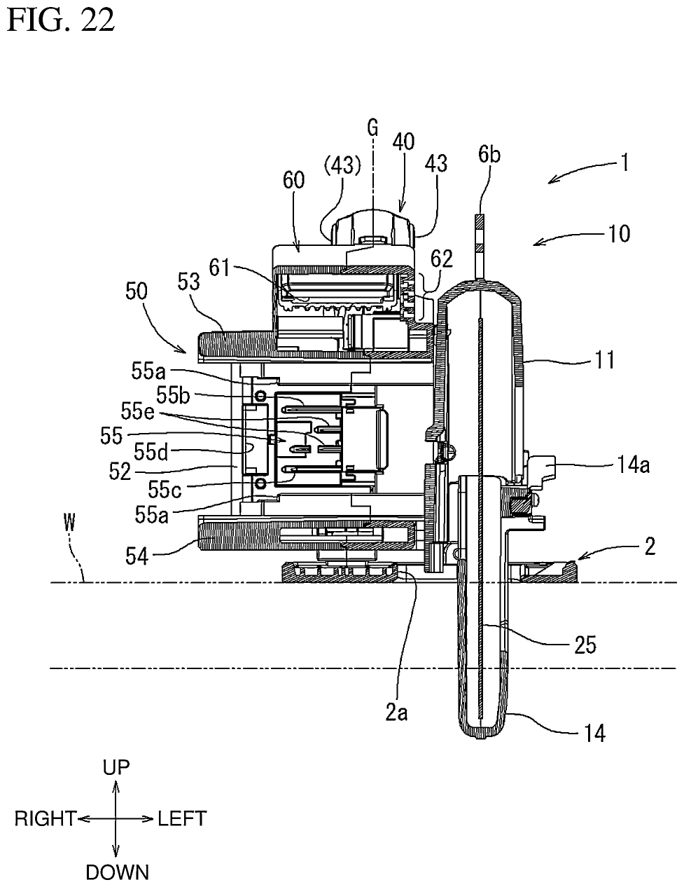

As shown in FIG. 19, the upper wall 53 and the lower wall 54 are spaced apart to accommodate the width D of each of the battery packs 31S and 31L. The front wall 51 and the rear wall 52 are spaced apart to accommodate the height H of the large second battery pack 31L. As shown in FIG. 21, the upper wall 53 and the lower wall 54 extend rightward to substantially reach the right end of the small first battery pack 31S. As shown in FIG. 22, the rear wall 52 extends by a lesser degree than the upper wall 53 and the lower wall 54 to avoid obstructing the release button 31a pressed for unlocking the attached small first battery pack 31S.

As shown in FIGS. 20 and 22, the rear wall 52 receives a terminal mount 55 on

the front surface. Similarly to the terminal mount 36 in the first embodiment, the terminal mount 55 includes a pair of upper and lower rail receivers 55a and positive and negative power terminals 55b and 55c. Two signal terminals 55e are located between the positive and negative power terminals 55b and 55c. The pair of rail receivers 55a extend in the lateral direction and parallel to each other on the upper and lower portions of the terminal mount 55. The positive and negative power terminals 55b and 55c are located between the upper and lower rail receivers 55a. The positive and negative power terminals 55b and 55c are spaced from each other in the vertical direction and extend in the lateral direction. The terminal mount 55 has a lock recess 55d on its right end for locking the battery pack 31 (31S, 31L) as attached.

As in the first embodiment, the battery pack 31 has the connection surface 31b or a coupling surface for connecting to the terminal mount 55. The connection surface 31b corresponds to the attachment surface B. Thus, as shown in FIG. 19, unlike in the first embodiment, the battery pack 31 has the attachment surface B orthogonal to the surface of the blade 25 in the second embodiment. As shown in FIG. 22, the battery attachment portion 50 and the terminal mount 55 partially extend over the width center G of the handle 40 to overlap an area adjacent to the blade 25. Thus, the battery pack 31 extends from the right area to the left area (adjacent to the blade 25) with respect to the width center G of the handle 40.

As shown in FIGS. 21 and 22, the battery attachment portion 50 for receiving the battery pack 31 (31S, 31L) extends from the right area and over the width center G of the handle 40 to an area adjacent to the blade 25. Thus, the battery pack 31 (31S, 31L) is slid to be attached from the right area over the width center G of the handle 40 to overlap an area adjacent to the blade 25.

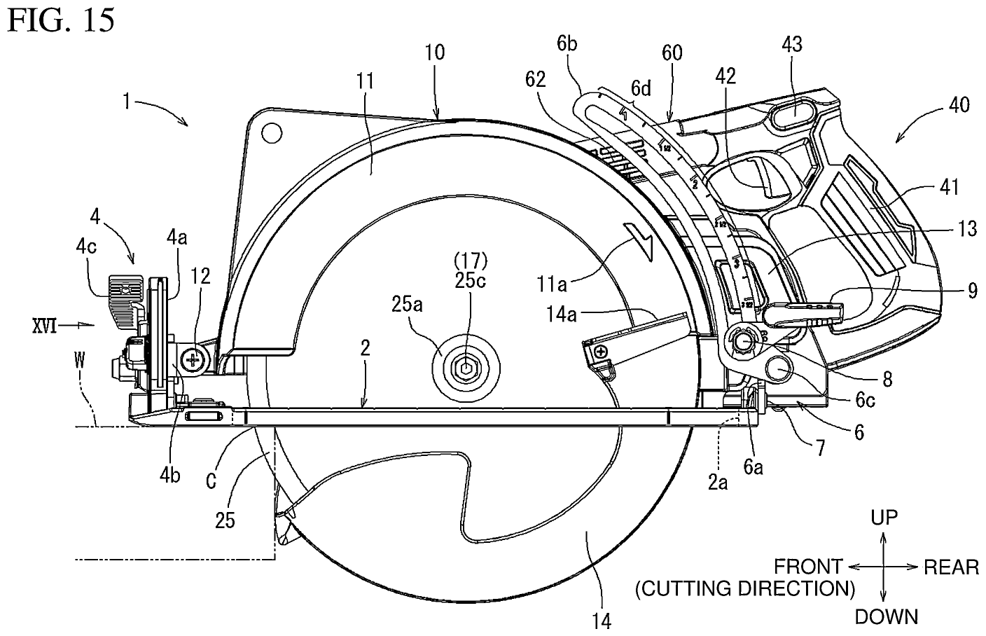

The portable cutting machine 1 according to the second embodiment includes a controller compartment 60 above the battery attachment portion 50. The controller compartment 60 accommodates a controller 61 for controlling the motor. In the second embodiment, cooling air for the electric motor 20 does not flow into the controller compartment. As shown in FIGS. 15, 18, 21, and 22, the controller compartment has multiple outlets 62 with sufficient opening areas in the left surface. In the second embodiment, the outlets 62 allow efficient cooling of the controller 61.

In the second embodiment, the battery pack 31 (31S, 31L) is slid in the lateral direction to be attached or detached. In this embodiment, the battery pack 31 (31S, 31L) is also attached to extend over the width center G of the handle 40 to overlap an area adjacent to the blade 25. Thus, the battery pack 31 (31S, 31L) extends from the right area to the left area (adjacent to the blade 25) with respect to the width center G of the handle 40. This allows the battery pack 31 to be attached in a space-efficient manner in the lateral or width direction, allowing the use of the large second battery pack 31L easily.

In the second embodiment, the large second battery pack 31L also extends over the width center G of the handle 40 to overlap an area adjacent to the blade 25. Thus, the large second battery pack 31L has the center of gravity closer to the width center G of the handle 40. This avoids poor grip on the handle 40 caused by an unbalanced weight in the lateral direction due to the large battery pack 31. With the large second battery pack 31L attached, the user can move the portable cutting machine 1 by gripping the handle 40 more easily.

In the second embodiment, the front wall 51, the rear wall 52, the upper wall 53, and the lower wall 54 surround the battery pack 31. Thus, the walls 51 to 54 serve as a guard for the attached battery pack 31 to prevent damage to the battery pack 31.

The battery attachment portion 50 in the second embodiment has the attachment surface B substantially standing with respect to the base 2. In particular, as shown in FIG. 20, the attachment surface B is substantially orthogonal to the base 2 with the cutting machine body 10 swung down to have the maximum cutting depth. Thus, the rail receivers 55a and other contact or engaged portions partially receive the full weight of the battery pack 31, as in the first embodiment. The battery attachment portion 50 can thus receive the heavy and large second battery pack 31L with no or less additional reinforcement for, for example, the rail receivers 55a or parts near the rail receivers 55a.

The first and second embodiments described above may be modified further. For example, although the portable cutting machine 1 in the above embodiments has the blade 25 on the left of the handle 40 as viewed from a user, a portable cutting machine may have a blade on the right of the handle 40. Such a portable cutting machine can also include the illustrated battery attachment structure. In a portable cutting machine having a blade and a stationary cover on the right of the handle 40, the battery pack 31 (31S, 31L) extends from the left to right areas (adjacent to the blade) with respect to the width center G of the handle 40. This structure also allows the large second battery pack 31L to be attached in a space-efficient manner in the width direction. The large second battery pack 31L has the center of gravity closer to the handle 40, thus allowing good grip on the handle 40 (an equally balanced weight in the lateral direction). The portable cutting machine can thus readily use the large second battery pack 31L.

Although the attachment surface B is orthogonal to the base 2 in the above embodiments, the attachment surface B may extend diagonally to the base 2. For example, the attachment surface B may be tilted in one direction or another at an angle of up to about 45° to a plane orthogonal to the base 2. The diagonally extending attachment surface B can also receive the heavy and large second battery pack 31L without much reinforcement for, for example, the rail receivers or parts near the rail receivers. The diagonally extending attachment surface B, which allows the battery pack 31 to be attached or detached diagonally to the base 2, allows any reinforcement without compromising easy attachment or detachment in a smaller space.

Although the portable cutting machine 1 in the above embodiments selectively receives two different battery packs 31S and 31L having different heights H, the portable cutting machine 1 may selectively receive three or more different battery packs having different heights (and thus having different capacities).

The portable cutting machine 1 may further selectively receive multiple different battery packs 31 having different lengths L, different widths D, or different heights H and having the common connection surface 31b. Any of these battery packs 31 is attached to extend from one of the right and left areas from the width center G of the handle 40 to the other area, thus being compact and having an equally balanced weight.

Although the portable cutting machine 1 in the above embodiments is a rear handle saw having the handle 40 largely protruding rearward, the illustrated battery attachment structure may be used for a typical portable circular saw having a more compact handle. The portable cutting machine may include a diamond wheel or a grinding disc as a blade, instead of a tipped saw blade.

The portable cutting machine 1 in the above embodiments includes the cutting machine body 10 accommodating the electric motor 20. The portable cutting machine 1 includes the disc-shaped blade 25 rotatably attached to the right or left of the cutting machine body 10. The portable cutting machine 1 includes the front grip (sub grip 45) on a front portion of the cutting machine body 10, the rear handle (handle 40) on a rear portion of the cutting machine body 10, and the battery attachment portion 30 (50) for receiving the battery pack 31 (31S, 31L) between the front grip and the rear handle. The battery attachment portion 30 (50) has the front surface (front wall 34, 51) to face the front surface of the battery pack 31 (31S, 31L), the rear surface (rear wall 35, 52) to face the rear surface of the battery pack 31 (31S, 31L), and the lateral opening to expose the battery pack 31 (31S, 31L) in the direction away from the blade 25. The battery attachment portion 30 (50) also includes the lateral surface opposite to the lateral opening, and the rail receivers 36a (55a) on any one of the lateral surface, the front surface, and the rear surface. The rail receivers 36a (55a) receive the rails 31d on the battery pack 31 (31S, 31L) in a detachable manner.

Thus, the battery pack 31 (31S, 31L) is attachable between the front grip and the rear handle. The battery attachment portion 30 (50) has the front surface facing the front surface of the attached battery pack 31 (31S, 31L), the rear surface facing the rear surface of the battery pack 31 (31S, 31L), and the lateral opening located in the lateral direction from the battery pack 31 (31S, 31L). Thus, the battery pack 31 (31S, 31L) is attached or detached in the vertical direction or the lateral direction. The battery attachment portion 30 (50) includes the rail receivers 36a (55a) on any one of the lateral surface, the front surface, and the rear surface. In each case, the battery attachment portion 30 (50) has the attachment surface B extending in the vertical direction (or standing with respect to the base 2). Thus, portions other than the rail receivers 36a (55a), such as portions in contact with or engaged with the battery pack 31 (31S, 31L) also partially receive the full weight of the battery pack 31 (31S, 31L). This allows the battery attachment portion 30 (50) to receive a larger and heavier battery pack 31L with no or less additional reinforcement. The portable cutting machine 1 can thus avoid being upsized and becoming heavy. The battery attachment portion 30 (50) has the lateral opening to expose the battery pack 31 (31S, 31L) in the direction away from the blade 25. This allows attachment of the large second battery pack 31L that uses a large attachment space on the right or left portion.

The portable cutting machine 1 according to the first embodiment includes the battery attachment portion 30 including the rail receivers 36a on the lateral surface and the upper opening to expose the upper surface of the battery pack 31 (31S, 31L). Thus, the battery pack 31 (31S, 31L) is attached or detached in the vertical direction. The battery pack 31 (31S, 31L) is slid in the vertical direction along the rail receivers 36a to be attached to or detached from the battery attachment portion 30. The base 2 does not obstruct the attachment or detachment.

The rail receivers 36a in the first embodiment allow the battery pack 31 (31S, 31L) to be detached upward. Thus, the battery pack 31 (31S, 31L) is slid upward for detachment from the battery attachment portion 30 and slid downward for attachment to the battery attachment portion 30.

The battery attachment portion 50 in the second embodiment includes the rail receivers 55a located on the rear (or front) surface, the lower surface (lower wall 54) to cover the lower surface of the battery pack 31 (31S, 31L), and the upper surface (upper wall 53) to cover the upper surface of the battery pack 31 (31S, 31L). Thus, the battery pack 31 (31S, 31L) is attached or detached in the lateral (right-left) direction through the opening in a lateral surface other than the upper, lower, front, or rear surface.

The rail receivers 55a in the second embodiment allow the battery pack 31 (31S, 31L) to be detached through the lateral opening. Thus, the battery pack 31 (31S, 31L) is slid to and through the lateral opening to be detached from the battery attachment portion 50.

The illustrated rail receivers 36a (55a) are located to allow the battery pack 31 (31S, 31L) on the rail receivers 36a (55a) to extend over the center plane of the rear handle (handle 40) in the lateral direction. Thus, the battery pack 31 (31S, 31L) is attached to extend over the center plane (width center G) of the rear handle in the lateral direction. This allows the portable cutting machine 1 to be compact.

The illustrated battery attachment portion 30 (50) selectively receives the first battery pack 31S and the second battery pack 31L having different dimensions. Each of the first battery pack 31S and the second battery pack 31L includes the rails 31d to be attached to the common rail receivers 36a (55a). Thus, the common rail receivers 36a (55a) selectively receive the first battery pack 31S and the second battery pack 31L having different dimensions. The battery attachment portion 30 (50) with a simple structure can selectively receive the small and large battery packs 31S and 31L, with the battery packs 31S and 31L having the common rails 31d attachable to the common rail receivers 36a (55a).

In the first and second embodiments, each of the small first battery pack 31S and the large second battery pack 31L has the rail surface (connection surface 31b) including the rails 31d, the thickness (height H) orthogonal to the rail surface, and the length L along the rails 31d. The first battery pack 31S and the second battery pack 31L have different thicknesses (heights H) and/or different lengths L. The first and second battery packs 31S and 31L with different thicknesses (heights H) and/or different lengths L have the common rails 31d. The battery attachment portion 30 (50) includes the common rail receivers 36a (55a) to receive both the first and second battery packs 31S and 31L. Thus, the first and second battery packs 31S and 31L with different thicknesses (heights H) and/or different lengths L can be attached to the common battery attachment portion 30 (50). The battery attachment portion 30 (50), which has the attachment surface extending in the vertical direction (or standing with respect to the base 2), can receive any of these battery packs 31 or a larger and heavier battery pack 31L with no or less additional reinforcement. The portable cutting machine 1 can thus avoid being upsized and becoming heavy.

### REFERENCE SIGNS LIST

W workpiece
1 portable cutting machine (rear handle saw)
2 base
2a window
4 front tilt support
4a angular plate
4b tilt bracket
4c locking lever
4d angle marking
4e indicator
5 front lateral tilt support shaft
6 rear tilt support
6a base bracket
6b depth guide
6c front-rear pivot shaft
6d depth scale
7 rear lateral tilt support shaft
8 body fastener screw
9 locking lever
10 cutting machine body
11 stationary cover
11a solid-white arrow (rotation direction of blade)
11b dust collecting port
11c cap
12 vertical swing support shaft
13 handle support
13a indicator
14 movable cover
14a open-close lever
15 reduction gear
15a gear housing
15b outlet
16 follower gear
17 spindle
20 electric motor
21 motor housing
21a inlet
21b air vent
22 stator
23 rotor
24 motor shaft
J motor axis
24a driving gear
24b bearing (front)
24c bearing (rear)
25 blade
25a outer flange
25b inner flange
25c fastener screw
C cutting portion
27 cooling fan
28 sensor board
30 battery attachment portion (first embodiment)
31 battery pack
31a release button
31b connection surface
31c lock tab
31d rail
31e terminal slot (positive)
31f terminal slot (negative)
31g signal terminal slot
31h lower surface
31i battery indicator
31S first battery pack (small)
31L second battery pack (large)
B attachment surface
L length
D width
H height
32 controller compartment
32a outlet
33 controller
33a control board
34 front wall
35 rear wall
36 terminal mount
36a rail receiver
36b power terminal (positive)
36c power terminal (negative)
36d lock recess
36e signal terminal
40 handle
G width center
41 grip
42 switch lever
43 unlock button
45 sub grip
45a grip
45b, 45c screw
46 adapter compartment
46a communication adapter
50 battery attachment portion (second embodiment)
51 front wall
52 rear wall
53 upper wall
54 lower wall
55 terminal mount
55a rail receiver
55b power terminal (positive)
55c power terminal (negative)
55d lock recess
55e signal terminal
60 controller compartment
61 controller
62 outlet

What is claimed is:

1. A portable cutting machine, comprising:
a brushless motor having a motor axis extending in a lateral direction;
a base configured to come in contact with a workpiece;
a cutting machine body coupled to an upper surface of the base, the cutting machine body accommodating the brushless motor;
a handle protruding rearward from a rear end of the cutting machine body;
a blade disposed on a left or right side of the handle, the blade configured to be rotated by the brushless motor to cut the workpiece in a front-rear direction;
a battery attachment portion configured to detachably receive a battery pack in a vertical direction, the battery attachment portion including a terminal mount disposed closer to the blade in the lateral direction, the terminal mount being open in a direction opposite to the blade; and
a controller disposed frontward from the battery attachment portion, the controller entirely disposed above the motor axis.

2. The portable cutting machine according to claim 1, further comprising:
a sub grip disposed above the brushless motor in a lateral side of the blade,
wherein the controller has an upper end located lower than an upper end of the sub grip.

3. The portable cutting machine according to claim 1, further comprising:
a cooling fan configured to rotate integrally with the brushless motor,
wherein the controller is cooled by cooling air generated by the cooling fan.

4. The portable cutting machine according to claim 1, wherein
the controller extends parallel to the motor axis and is inclined in the front-rear direction.

5. The portable cutting machine according to claim 1, wherein
the upper surface of the base is visible from above with the battery pack detached from the battery attachment portion.

6. The portable cutting machine according to claim 1, wherein
the cutting machine body includes a motor housing accommodating the brushless motor, and
the motor housing protrudes in the direction opposite to the blade than the battery pack in the lateral direction.

7. The portable cutting machine according to claim 1, wherein
when the battery pack having a battery indicator on a face is attached to the battery attachment portion, the battery indicator is located on an upper face.

8. The portable cutting machine according to claim 1, wherein the blade is disc-shape.

9. The portable cutting machine according to claim 1, wherein
the base is rectangular,
the portable cutting machine further comprising:
a vertical swing support shaft disposed in a front portion on the upper surface of the base to support the blade in a swingable manner.

10. The portable cutting machine according to claim 8, further comprising:
a stationary cover covering substantially an upper half of the blade.
